(19) United States
(12) Patent Application Publication
(10) Pub. No.: US 2026/0065823 A1
(43) Pub. Date: Mar. 5, 2026

(54) DISPLAY DEVICE, CONTROL DEVICE, AND CONTROL METHOD

(71) Applicant: Sharp Display Technology Corporation, Kameyama City (JP)

(72) Inventor: Masashi MAYUMI, Kameyama City (JP)

(21) Appl. No.: 19/305,114

(22) Filed: Aug. 20, 2025

(30) Foreign Application Priority Data
Aug. 29, 2024 (JP) 2024-147925

(51) Int. Cl. G09G 3/02; G06F 3/041; G06F 3/042

(52) U.S. Cl. CPC G09G 3/02; G06F 3/04166; G06F 3/042; G06F 2203/04101; G09G 2330/023; G09G 2340/0435; G09G 2354/00; G09G 2358/00

(57) ABSTRACT

A display device is able to present a first image to a first user positioned on a first side with respect to a display surface and to present a second image to a second user positioned on a second side with respect to the display surface. The second side is a side different from the first side. The second image is an image different from the first image. The display device includes a distance sensor that detects a distance between an object and each of multiple partial areas which belong to the display surface. The display device determines, based on the distance detected by the distance sensor, from which one of the first side and the second side the object is performing an operation for the display surface.

### BACKGROUND

### 1. Field

The present disclosure relates to a display device, a control device, and a control method.

### 2. Description of the Related Art

A display device that can present multiple images on a single display surface in accordance with the viewing directions of users (viewers) is called a multiview display device. Japanese Unexamined Patent Application Publication No. 2008-257446 discloses an example of the configuration of the multiview display device.

It is desirable to detect an operation performed for the display surface of a multiview display device by employing a novel approach different from the related art.

### SUMMARY

A display device according to an aspect of the disclosure is able to present a first image to a first user positioned on a first side with respect to a display surface and to present a second image to a second user positioned on a second side with respect to the display surface. The second side is a side different from the first side. The second image is an image different from the first image. The display device includes a distance sensor that detects a distance between an object and each of multiple partial areas which belong to the display surface. The display device determines, based on the distance detected by the distance sensor, from which one of the first side and the second side the object is performing an operation for the display surface.

A control device according to an aspect of the disclosure controls a display device. The display device is able to present a first image to a first user positioned on a first side with respect to a display surface and to present a second image to a second user positioned on a second side with respect to the display surface. The second side is a side different from the first side. The second image is an image different from the first image. From a distance sensor that detects a distance between an object and each of multiple partial areas which belong to the display surface, the control device obtains the distance detected by the distance sensor. The control device determines, based on the obtained distance, from which one of the first side and the second side the object is performing an operation for the display surface.

A control method according to an aspect of the disclosure is a method for controlling a display device. The display device is able to present a first image to a first user positioned on a first side with respect to a display surface and to present a second image to a second user positioned on a second side with respect to the display surface. The second side is a side different from the first side. The second image is an image different from the first image. The control method includes: obtaining, from a distance sensor that detects a distance between an object and each of multiple partial areas which belong to the display surface, the distance detected by the distance sensor; and determining, based on the obtained distance, from which one of the first side and the second side the object is performing an operation for the display surface.

### BRIEF DESCRIPTION OF THE DRAWINGS

FIG. 1 is a block diagram illustrating an example of the configuration of a display device according to a first embodiment;

FIG. 2 schematically illustrates dual-view display in the display device of the first embodiment;

FIG. 3 schematically illustrates the display surface of the display device;

FIG. 4 illustrates various examples of the positional arrangement of a distance sensor;

FIG. 5 is a conceptual view for explaining a 4×4-mode multizone sensor;

FIG. 6 is a conceptual view for explaining an 8×8-mode multizone sensor;

FIG. 7 illustrates an example of blocks each constituted by multiple partial areas in a multizone sensor;

FIG. 8 illustrates an example in which the display surface and an object are close to each other neither in a first block nor in a second block;

FIG. 9 illustrates an example in which the display surface and an object have become close to each other in the first block;

FIG. 10 illustrates an example in which the display surface and an object have become close to each other in the second block; and

FIG. 11 is a block diagram illustrating an example of the configuration of a display device according to a second embodiment.

### DESCRIPTION OF THE EMBODIMENTS

### First Embodiment

A first embodiment will be described below. For the sake of description, a component (element) having the same function as that to be explained in the first embodiment is designated by like reference numeral in another embodiment and an explanation thereof will not be repeated. For the sake of simplicity, an explanation of points similar to the related art will also be omitted.

Components and numerical values discussed in the specification are merely examples and other components and numerical values may be employed as long as there is no technical inconsistencies. The positional relationships and connection relationships of the components are not limited to the examples in the drawings and other positional relationships and connection relationships of the components may be employed as long as there is no technical inconsistencies.

### (Configuration Example of Display Device 1)

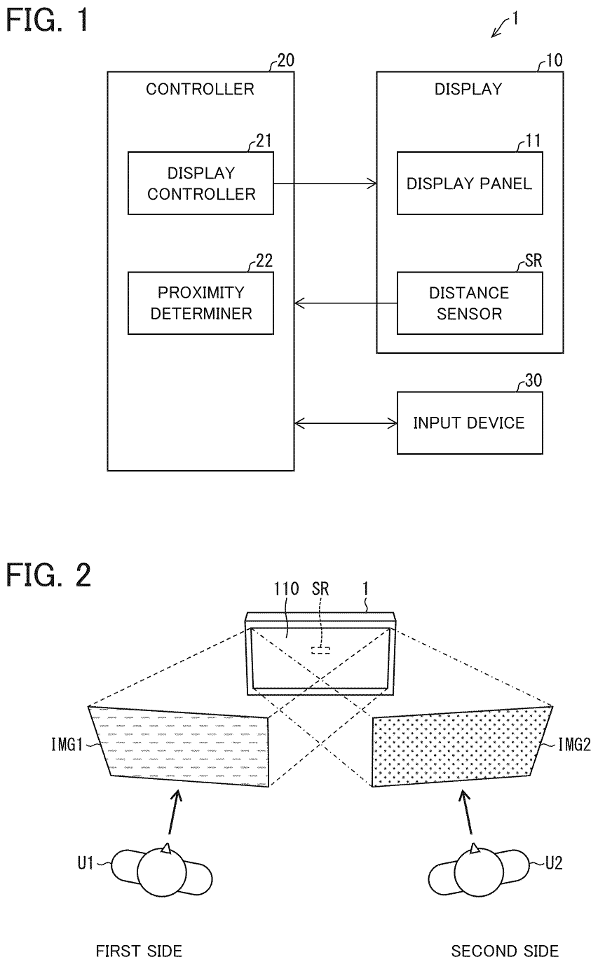

FIG. 1 is a block diagram illustrating an example of the configuration of a display device 1 according to the first embodiment. The display device 1 includes a display 10 and a controller 20. The controller 20 centrally controls the components of the display device 1. The controller 20 serves as a display control device that controls a display operation of the display 10. The controller 20 is thus an example of a control device according to an aspect of the disclosure.

The display 10 includes a display panel 11. The controller 20 includes a display controller 21. The display controller 21 controls the display 10. In the first embodiment, the display panel 11 is assumed to be a liquid crystal panel, for example. In this case, the display controller 21 may control the display panel 11. The display controller 21 may also control a light source (not shown), such as a backlight, of the display 10.

The display device 1 includes a distance sensor SR. In the example in FIG. 1, the distance sensor SR is built in the display 10. The controller 20 includes a proximity determiner 22. The proximity determiner 22 obtains detection results of the distance sensor SR and executes proximity determining processing, which will be discussed later.

The display device 1 in the first embodiment is a multiview display device. For the sake of clarification, in the first embodiment, the display device 1 is assumed as a dual-view display device, for example. The display device 1 can thus present two individual images in accordance with the viewing directions of users. In other words, the display device 1 implements dual-view display in accordance with the viewing directions of users.

In the specification, one of two individual images in dual-view display will be called a first image, while the other image will be called a second image. In the example in the first embodiment, the second image is assumed as an image different from the first image.

FIG. 2 schematically illustrates dual-view display in the display device 1. In the example in FIG. 2, two users (viewers) viewing images displayed on the display device 1 are shown. In the specification, one of the two users will be called a first user U1, while the other user will be called a second user U2.

In the specification, it is assumed that the first user U1 is located at a first position with respect to a display surface 110 of the display device 1, while the second user U2 is located at a second position with respect to the display surface 110. In the example of the first embodiment, the second position is assumed as a position different from the first position.

In the example in FIG. 2, the side on which the first user U1 is positioned with respect to the display surface 110 will be called a first side. The side on which the second user U2 is positioned with respect to the display surface 110 will be called a second side. The second side is accordingly a side different from the first side.

In the example in FIG. 2, the first side is the left side with respect to the display surface 110, while the second side is the right side with respect to the display surface 110. In the example in FIG. 2, the second side is the side opposite the first side. In the example in FIG. 2, a first image IMG1 is an image to be presented to the first user U1, while a second image IMG2 is an image to be presented to the second user U2.

An example in which the display device 1 is installed in a vehicle, such as an automobile, will be discussed below. An example of the first user U1 is a user sitting in the driver's seat of the automobile. The first image IMG1 may be a content image indicating information for driving, such as an image to be displayed in a car navigation system.

An example of the second user U2 is a user sitting in a passenger seat of the automobile. The second image IMG2 may be a content image different from the first image IMG1, such as an image indicating the air-conditioning state in the automobile.

Referring back to FIG. 1, the display device 1 includes an input device 30. The input device 30 is not limited to a particular type as long as it can receive an operation for the display surface 110 from each user. In the example of the first embodiment, it is assumed that each of the first user U1 and the second user U2 can perform an operation for the display surface 110 via the input device 30. The controller 20 controls the display 10 in accordance with the operation performed for the display surface 110.

In the first embodiment, the input device 30 is disposed so that (i) the first user U1 can perform an operation on the input device 30 from the first side and (ii) the second user U2 can perform an operation on the input device 30 from the second side. In the example of the first embodiment, it is thus assumed that the input device 30 is located near the display surface 110.

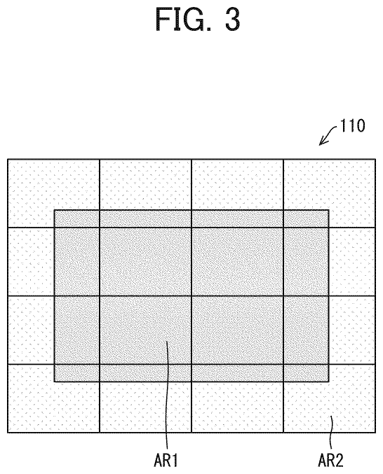

FIG. 3 schematically illustrates the display surface 110. The display surface 110 has an active area AR1 and a border area AR2. As shown in FIG. 3, the border area AR2 is located at the outer peripheral portion of the display surface 110. The active area AR1 is thus surrounded by the border area AR2. The active area AR1 is an area of the display surface 110 where an image is displayed. The border area AR2 is an area of the display surface 110 where no image is displayed.

As illustrated in FIG. 3, in the example of the first embodiment, the display surface 110 can be divided into multiple partial areas. The total number of partial areas is determined by the specifications of the distance sensor SR, which will be discussed later. In the example in FIG. 3, the display surface 110 is divided into 16 partial areas.

In the example of the first embodiment, the distance sensor SR is located to detect the distance between an object and each of the partial areas which belong to the display surface 110. As the distance sensor SR, a multizone sensor, for example, may be used. The single distance sensor SR can detect the above-described multiple distances. In the example of the first embodiment, only one distance sensor SR is used.

There are two types of multizone sensors, that is, an infrared sensor and a capacitive sensor are known. In terms of the upper limit value of the detectable distance, an infrared multizone sensor is superior over a capacitive multizone sensor. In the example of the first embodiment, therefore, an infrared multizone sensor is used as the distance sensor SR.

Typically, it is difficult for a capacitive multizone sensor to detect distances of about 100 millimeters (mm) or longer. In contrast, an infrared multizone sensor can detect distances of about 3000 mm or longer.

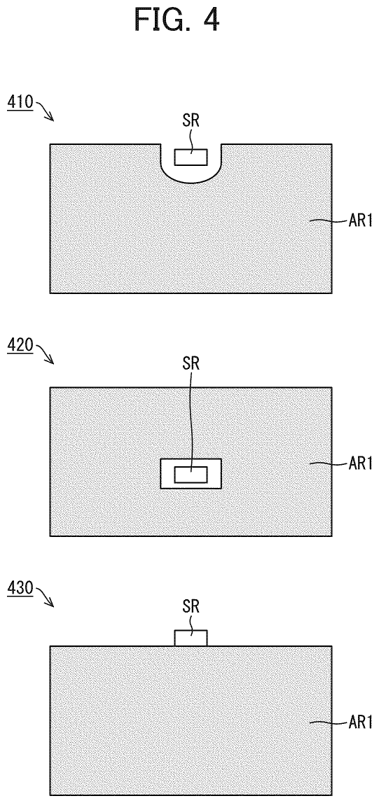

FIG. 4 illustrates various examples of the positional arrangement of the distance sensor SR. In FIG. 4, the positional relationships between the distance sensor SR and the active area AR1 are schematically shown. In examples 410 and 420 shown in FIG. 4, the distance sensor SR is located at a position other than in the border area AR2 (not shown in FIG. 4).

In the example 410, the distance sensor SR is positioned in or near a boundary between the active area AR1 and the border area AR2. In the example 420, the distance sensor SR is positioned in or near the central portion of the active area AR1. In the example 420, the distance sensor SR is thus located in or near the central portion of the display surface 110.

In the examples 410 and 420, to allow infrared emitted from the distance sensor SR and infrared reflected by an object to pass through the display surface 110, an aperture is formed in the active area AR1. That is, in the examples 410 and 420, an aperture is formed in the active area AR1 to expose the distance sensor SR.

In an example 430 in FIG. 4, the distance sensor SR is positioned within the border area AR2, which is not shown. In this case, there is no need to form an aperture in the active area AR1 to expose the distance sensor SR.

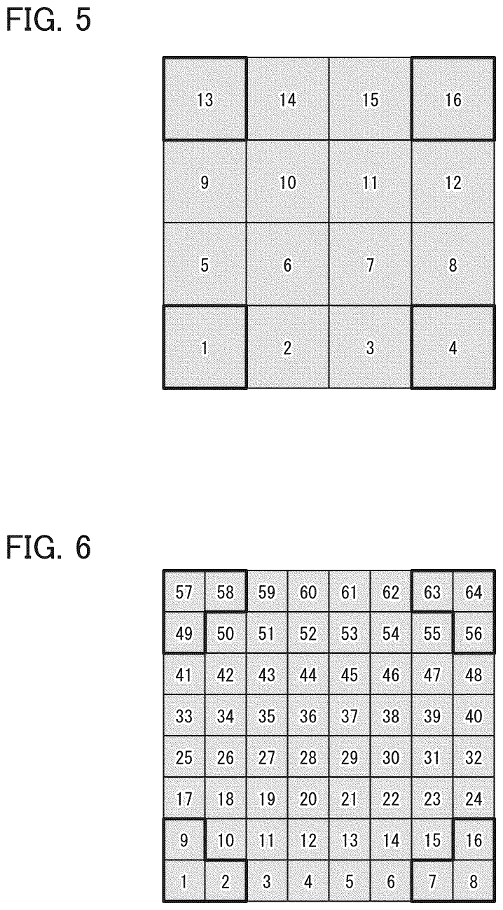

FIG. 5 is a conceptual view for explaining a 4×4-mode multizone sensor. The multizone sensor is designed so that the entire area to be detected can be divided into 16 partial areas. The multizone sensor is able to detect the distance between an object and each of the 16 partial areas.

In the example in FIG. 5, the 16 partial areas are appended with the corresponding numbers. In the specification, the partial area appended with the number “1”, for example, will be called a first partial area. The first partial area in the example in FIG. 5 is located at a bottom left corner of the entire area. The fourth partial area is located at a bottom right corner of the entire area. The thirteenth partial area is located at a top left corner of the entire area. The sixteenth partial area is located at a top right corner of the entire area.

In the example in FIG. 5, the first area will be called a bottom left corner area. The fourth partial area will be called a bottom right corner area. The thirteenth partial area will be called a top left corner area. The sixteenth partial area will be called a top right corner area.

In the specification, the bottom left corner area, bottom right corner area, top left corner area, and top right corner area will collectively be called corner areas. In contrast, partial areas other than the corner areas will be called non-corner areas. The non-corner areas in the example in FIG. 5 are constituted by 12 partial areas.

FIG. 6 is a conceptual view for explaining an 8×8-mode multizone sensor. The 8×8-mode multizone sensor shown in FIG. 6 is one mode of the multizone sensor, as well as the 4×4-mode multizone sensor in FIG. 5. The multizone sensor in the example in FIG. 6 is designed so that the entire area to be detected can be divided into 64 partial areas. The multizone sensor is able to detect the distance between an object and each of the 64 partial areas. The multizone sensor in the example in FIG. 6 has thus higher spatial resolution than that in the example in FIG. 5.

In the example in FIG. 6, each corner area is constituted by three partial areas. The bottom left corner area is constituted by the first, second, and ninth partial areas. The bottom right corner area is constituted by the seventh, eighth, and sixteenth partial areas. The top left corner area is constituted by the forty-ninth, fifty-seventh, and fifty-eighth partial areas. The top right corner area is constituted by the fifty-sixth, sixty-third, and sixty-fourth partial areas. The non-corner areas in the example in FIG. 6 are constituted by 52 partial areas.

The multizone sensor in the example in FIG. 5 or that in the example in FIG. 6 may be used as the distance sensor SR. For the sake of clarification, the first embodiment will be explained below, assuming that the multizone sensor in the example in FIG. 5 is used as the distance sensor SR.

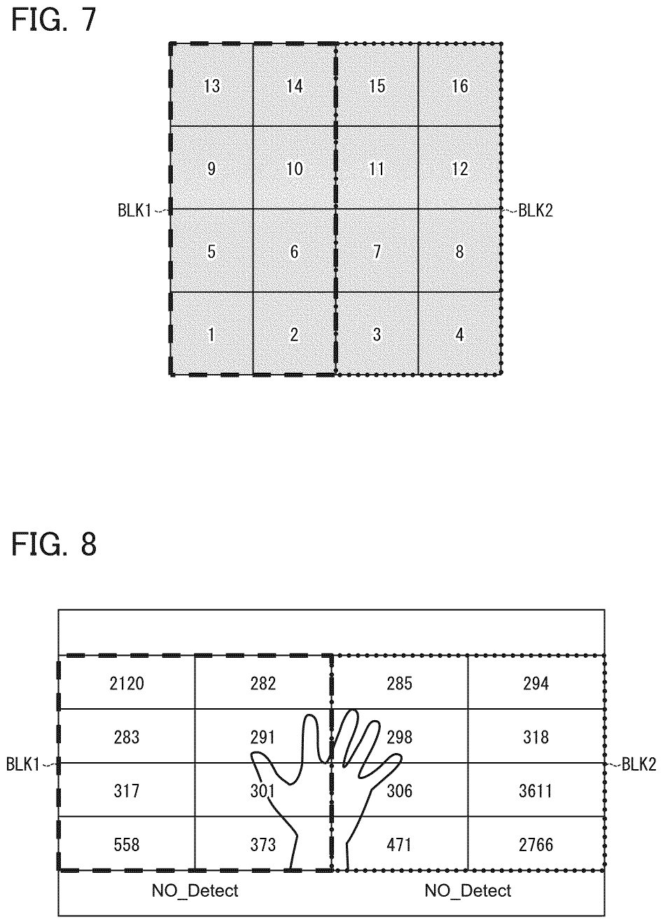

FIG. 7 illustrates an example of blocks each constituted by multiple partial areas in the multizone sensor. In the example in FIG. 7, the entire area to be detected is divided into a first block BLK1 and a second block BLK2. The first block BLK1 and the second block BLK2 may be preset by the designer of the display device 1.

The first block BLK1 in the example in FIG. 7 is constituted by eight partial areas on the left side of the entire area. The first block BLK1 in the example in FIG. 7 may thus be called a left side block. The first block BLK1 in the example in FIG. 7 is constituted by the first, second, fifth, sixth, ninth, tenth, thirteenth, and fourteenth partial areas.

It can be said that the first block BLK1 in the example in FIG. 7 is a block corresponding to the above-described first side. Hence, focusing on the values detected by the multizone sensor (hereinafter may also be simply called the detected values) in the partial areas belonging to the first block BLK1 may be effective for determining whether the user U1 and the display surface 110 have become close to each other.

The second block BLK2 in the example in FIG. 7 is a portion of the entire area other than the first block BLK1. The second block BLK2 in the example in FIG. 7 is constituted by eight partial areas on the right side. The second block BLK2 in the example in FIG. 7 may thus be called a right side block. The second block BLK2 in the example in FIG. 7 is constituted by the third, fourth, seventh, eighth, eleventh, twelfth, fifteenth, and sixteenth partial areas.

It can be said that the second block BLK2 in the example in FIG. 7 is a block corresponding to the above-described second side. Hence, focusing on the detected values in the partial areas belonging to the second block BLK2 may be effective for determining whether the user U2 and the display surface 110 have become close to each other.

### (Processing Example of Proximity Determiner 22)

An example of processing executed by the proximity determiner 22 will now be described below with reference to FIGS. 8 through 10. It is assumed that, in the examples in FIGS. 8 through 10, the first block BLK1 and the second block BLK2 are set, as in the example in FIG. 7.

In the examples in FIGS. 8 through 10, the numerical value indicated in a partial area represents the detected value of the distance in this partial area. In the examples in FIGS. 8 through 10, the unit of the numerical values of the distance is millimeter (mm). It is assumed that, in the examples in FIGS. 8 through 10, a threshold is set for the detected values of the distance. This threshold will be called the distance threshold. In the first embodiment, the distance threshold is set to be 250 mm, for example.

In the specification, among the partial areas belonging to the first block BLK1, the number of partial areas whose detected values are smaller than or equal to the distance threshold will be called a first given number. Among the partial areas belonging to the second block BLK2, the number of partial areas whose detected values are smaller than or equal to the distance threshold will be called a second given number. The proximity determiner 22 determines the first given number and the second given number based on the detection results of the distance sensor SR.

It is assumed that, in the examples in FIGS. 8 through 10, a threshold is set for the first given number and the second given number. This threshold will be called a number threshold. In the first embodiment, the number threshold is set to be four.

In the examples in FIGS. 8 through 10, a hand is an example of the object. In the examples in FIGS. 8 through 10, a scene where, to operate the display surface 110, a user is bringing the object to be close to the input device 30 located near the display surface 110 is assumed.
(1) If (i) the first given number is smaller than the number threshold and if (ii) the second given number is smaller than the number threshold, the proximity determiner 22 determines that the display surface 110 and the object are close to each other neither in the first block BLK1 nor in the second block BLK2.

FIG. 8 illustrates an example in which the display surface 110 and the object are close to each other neither in the first block BLK1 nor in the second block BLK2. In the example in FIG. 8, the object is separated from the display surface 110 at a relatively large distance. In the example in FIG. 8, the first given number and the second given number are both 0.

In the example in FIG. 8, therefore, the proximity determiner 22 determines that the display surface 110 and the object are close to each other neither in the first block BLK1 nor in the second block BLK2. In the example in FIG. 8, “NO_Detect” written under the first block BLK1 indicates that it is determined that the display surface 110 and the object are not close to each other in the first block BLK1. “NO_Detect” written under the second block BLK2 indicates that it is determined that the display surface 110 and the object are not close to each other in the second block BLK2.

As is seen from the foregoing explanation, if (i) the first given number is smaller than the number threshold and if (ii) the second given number is smaller than the number threshold, the proximity determiner 22 may determine that no object is performing any operation for the display surface 110 either from the first side or from the second side.
(2) If (i) the first given number is larger than or equal to the number threshold and if (ii) the first given number is larger than the second given number, the proximity determiner 22 determines that the display surface 110 and the object have become close to each other in the first block BLK1.

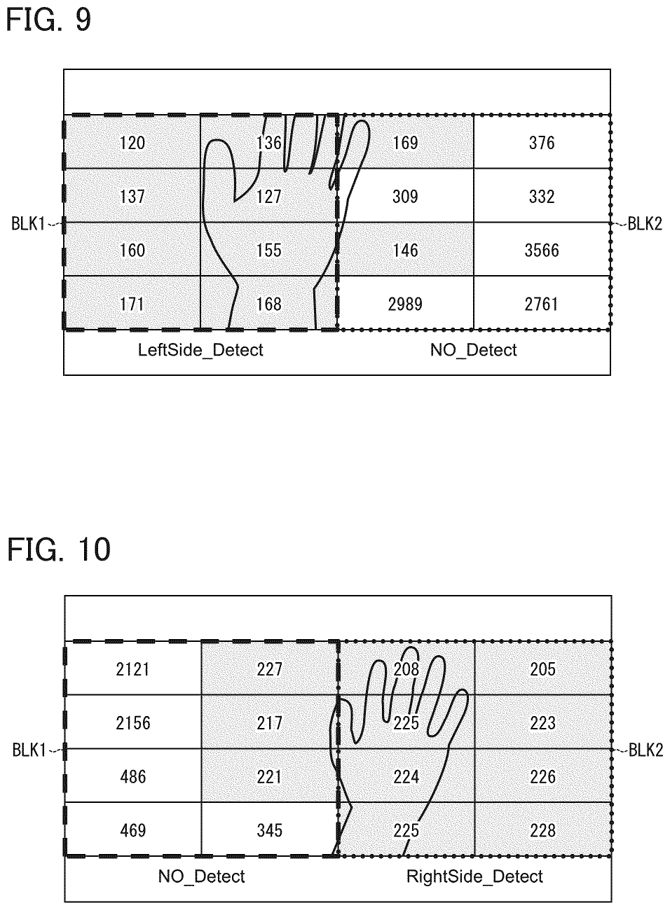

FIG. 9 illustrates an example in which the display surface 110 and the object have become close to each other in the first block BLK1. In the example in FIG. 9, the object is positioned toward the left side with respect to the display surface 110, compared with the object in the example in FIG. 8. Additionally, in the example in FIG. 9, the distance between the object and the display surface 110 is rather short. In the example in FIG. 9, (i) the first given number is larger than or equal to the number threshold and (ii) the first given number is larger than the second given number.

The proximity determiner 22 thus determines that the display surface 110 and the object have become close to each other in the first block BLK1. In the example in FIG. 9, “LeftSide_Detect” written under the first block BLK1 indicates that it is determined that the display surface 110 and the object have become close to each other in the first block BLK1 (left side block).

In the example in FIG. 9, the second given number is smaller than the number threshold. The proximity determiner 22 thus determines that the display surface 110 and the object are not close to each other in the second block BLK2.

As described above, if (i) the first given number is larger than or equal to the number threshold and if (ii) the first given number is larger than the second given number, the proximity determiner 22 may determine that the object is performing an operation for the display surface 110 from the first side.
(3) If (i) the second given number is larger than or equal to the number threshold and if (ii) the second given number is larger than the first given number, the proximity determiner 22 determines that the display surface 110 and the object have become close to each other in the second block BLK2.

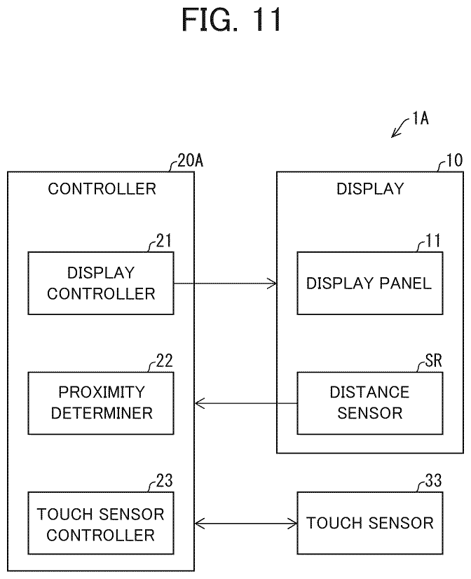

FIG. 10 illustrates an example in which the display surface 110 and the object have become close to each other in the second block BLK2. In the example in FIG. 10, the object is positioned toward the right side with respect to the display surface 110, compared with the object in the example in FIG. 8. In the example in FIG. 10, as well as in the example in FIG. 9, the distance between the object and the display surface 110 is rather short. In the example in FIG. 10, (i) the second given number is larger than or equal to the number threshold and (ii) the second given number is larger than the first given number.

The proximity determiner 22 thus determines that the display surface 110 and the object have become close to each other in the second block BLK2. In the example in FIG. 10, “RightSide_Detect” written under the second block BLK2 indicates that it is determined that the display surface 110 and the object have become close to each other in the second block BLK2 (right side block).

In the example in FIG. 10, the first given number is smaller than the number threshold. The proximity determiner 22 thus determines that the display surface 110 and the object are not close to each other in the first block BLK1.

As is seen from the above-described explanation, if (i) the second given number is larger than or equal to the number threshold and if (ii) the second given number is larger than the first given number, the proximity determiner 22 may determine that the object is performing an operation for the display surface 110 from the second side.

### Advantages

As described above, based on the detection results of the distance sensor SR, that is, the distance between an object and each of the partial areas which belong to the display surface 110, the display device 1 can determine at which one of the first side and the second side the display surface 110 and the object have become close to each other. This enables the display device 1 to determine from which one of the first side and the second side the object is performing an operation for the display surface 110, based on the detection results of the distance sensor SR.

The display device 1 can change the display mode of at least one of the first image and the second image, based on the detection results of the distance sensor SR. In one example, the display controller 21 may change the display mode of at least one of the first image and the second image, based on the determination result of the proximity determiner 22.

For instance, the display controller 21 may enable or disable the display function of at least one of the first image and the second image, based on the determination result of the proximity determiner 22. The display controller 21 may change the frame rate to display at least one of the first image and the second image, based on the determination result of the proximity determiner 22. Disabling the display function and reducing the frame rate both contribute to lowering the power consumption in the display device 1.

As discussed above, when the first user U1, for example, is trying to operate the input device 30, an object, which is part of the body of the first user U1, such as a finger, is likely to become close to the display surface 110.

Hence, if the display device 1 determines that the object and the first side of the display surface 110 have become close to each other, it may change the display mode of the first image. For example, if the display device 1 determines that the object is performing an operation from the first side of the display surface 110, it may change the display mode of the first image. In one example, the display device 1 may display an assistance icon, which serves as a guide for the operation of the first user U1, on the first side of the display surface 110.

The above-described explanation for the first user U1 and the first side of the display surface 110 is also applied to the second user U2 and the second side of the display surface 110. For example, if the display device 1 determines that an object and the second side of the display surface 110 have become close to each other, it may change the display mode of the second image. For example, if the display device 1 determines that the object is performing an operation from the second side of the display surface 110, it may change the display mode of the second image.

In the related art, such as the technology of Japanese Unexamined Patent Application Publication No. 2008-257446, multiple sensors (infrared sensors) are typically provided to determine which one of the left side (first side) and the right side (second side) of a display surface an object has approached.

In contrast, in the first embodiment, a multizone sensor, such as an infrared multizone sensor, is used as a sensor. With the use of the single multizone sensor, it is possible to determine at which one of the first side and the second side an object and the display surface have become close to each other, based on the detection results of this sensor. The cost of the sensor can thus be reduced, compared with the related art.

In the above-described publication of the related art, multiple sensors are disposed on the border area of the display surface. To secure a space for the multiple sensors, the border area is to be enlarged, which leads to a larger size of the display device.

Additionally, in the related art, it is not possible to dispose a sensor in or near the central portion of the display surface. Hence, when an object is positioned in or near the central portion, the accuracy in determining which one of the left side and the right side of the display device the object has approached may be lowered.

In contrast, in the first embodiment, the sensor is not disposed in the border area, as discussed above, thereby preventing the border area from being enlarged. As a result, the size of the display device can be reduced.

Additionally, in the first embodiment, the sensor can be disposed in or near the central portion of the display surface, as stated above. With this configuration, even when an object is positioned in or near the central portion of the display surface, the sensor can determine with high accuracy which one of the left side and the right side of the display device the object has approached.

As described above, according to the first embodiment, by using a novel approach different from the related art, it is possible to determine whether an object and the display surface of a multiview display device have become close to each other. This makes it possible to detect an operation performed for the display surface of the multiview display device in a manner different from the related art.

### Supplements

(1) In the first embodiment, an example in which the first given number and the second given number are different from each other has been discussed. However, there may be a case in which the first given number and the second given number are equal to each other. The designer of the display device 1 may predetermine processing to be executed when the first given number and the second given number are the same.

For example, if (i) the first given number and the second given number are equal to each other and if (ii) the first given number and the second given number are both larger than or equal to the number threshold, the proximity determiner 22 may determine that the display surface 110 and the object have become close to each other in a predetermined one (first block BLK1, for example) of the first block BLK1 and the second block BLK2.

If (i) the first given number and the second given number are equal to each other and if (ii) the first given number and the second given number are both larger than or equal to the number threshold, the proximity determiner 22 may determine that the object is performing an operation for the display surface 110 from the predetermined one (first side, for example) of the first side and the second side.
(2) When the first user U1 is trying to perform an operation for the display surface 110, it is more likely that the first user U1 brings his/her finger to be close to the left side of the display surface 110 rather than to the central portion of the display surface 110. When the second user U2 is trying to perform an operation for the display surface 110, it is more likely that the second user U2 brings his/her finger to be close to the right side of the display surface 110 rather than to the central portion of the display surface 110.

From this viewpoint, in addition to the first block BLK1 and the second block BLK2, a third block BLK3 may be set. In one example, the third block BLK3 may be set as the area belonging to the central portion of the display surface 110. The first block BLK1 may be set as the area on the left side of the display surface 110 with respect to the third block BLK3. The second block BLK2 may be set as the area on the right side of the display surface 110 with respect to the third block BLK3.

For example, if the multizone sensor in the example in FIG. 5 is used as the distance sensor SR, the third block BLK3 may be constituted by the second, third, sixth, seventh, tenth, eleventh, fourteenth, and fifteenth partial areas. In this case, the first block BLK1 may be constituted by the first, fifth, ninth, and thirteenth partial areas, while the second block BLK2 may be constituted by the fourth, eighth, twelfth, and sixteenth partial areas.

### Second Embodiment

FIG. 11 is a block diagram illustrating an example of the configuration of a display device 1A according to a second embodiment. The display device 1A includes a touch sensor 33. The touch sensor 33 is an example of the input device 30 discussed in the first embodiment.

In the second embodiment, it is assumed that the touch sensor 33 is disposed to overlap the display surface 110 of the display device 1A as seen from a line normal to the display surface 110. A user of the display device 1A can thus perform an operation on the touch sensor 33 by touching the display surface 110.

For example, the first user U1 can perform an operation on the touch sensor 33 from the first side, while the second user U2 can perform an operation on the touch sensor 33 from the second side.

The display device 1A includes a controller 20A. The controller 20A includes a touch sensor controller 23. The controller 20A can thus control the touch sensor 33 as well as the display 10.

The touch sensor controller 23 may control the touch sensor 33 based on the detection results of the distance sensor SR. In one example, the touch sensor controller 23 may change the operation mode of at least one of the first side and the second side of the touch sensor 33, based on the detection results of the distance sensor SR.

For example, the touch sensor controller 23 may change the operation mode of at least one of the first side and the second side of the touch sensor 33, based on the determination result of the proximity determiner 22.

For instance, the touch sensor controller 23 may enable or disable the input receiving function of at least one of the first side and the second side of the touch sensor 33, based on the determination result of the proximity determiner 22. The touch sensor controller 23 may change the scan rate of at least one of the first side and the second side of the touch sensor 33, based on the determination result of the proximity determiner 22. Disabling the input receiving function and reducing the scan rate both contribute to lowering the power consumption in the display device 1A.

In one example, if the display device 1A determines that an object and the first side of the display surface 110 have become close to each other, it may change the operation mode of the first side of the touch sensor 33. If the display device 1A determines that an object is performing an operation from the first side of the display surface 110, it may change the operation mode of the first side of the touch sensor 33.

Likewise, if the display device 1A determines that an object and the second side of the display surface 110 have become close to each other, it may change the operation mode of the second side of the touch sensor 33. If the display device 1A determines that an object is performing an operation from the second side of the display surface 110, it may change the operation mode of the second side of the touch sensor 33.

### [Software Implementation Examples]

The functions of the display devices 1 and 1A (hereinafter may simply be called the device) can be implemented by a program for causing a computer to function as the device and to function as the control blocks (components included in the controllers 20 and 20A, for example) of the device.

In this case, the device includes a computer provided with at least one control unit, such as a processor, and at least one storage element, such as a memory, as hardware for executing the program. The control unit and the storage element execute the program, thereby implementing the functions described in the first and second embodiments.

The program may be recorded on one or more non-transitory computer-readable recording mediums. The device may include such a recording medium or may not include it. If the device does not include such a recording medium, the above-described program may be supplied to the device via a wired or wireless transmission medium.

All or some of the functions of the control blocks may be implemented by a logic circuit. For example, an integrated circuit including a logic circuit that functions as the control blocks is also encompassed in one aspect of the disclosure. In another example, the functions of the control blocks may be implemented by a quantum computer.

The operations discussed in the first and second embodiments may be executed by artificial intelligence (AI). In this case, AI may be operated by the control unit or another unit, such as an edge computer or a cloud server.

### Conclusion

A display device according to a first aspect of the disclosure is able to present a first image to a first user positioned on a first side with respect to a display surface and to present a second image to a second user positioned on a second side with respect to the display surface. The second side is a side different from the first side. The second image is an image different from the first image. The display device includes a distance sensor that detects a distance between an object and each of multiple partial areas which belong to the display surface. The display device determines, based on the distance detected by the distance sensor, from which one of the first side and the second side the object is performing an operation for the display surface.

According to a second aspect of the disclosure, in the display device of the first aspect, the distance sensor may be an infrared multizone sensor.

According to a third aspect of the disclosure, in the display device of the first or second aspect, the distance sensor may be a single distance sensor.

According to a fourth aspect of the disclosure, in the display device of one of the first through third aspects, the distance sensor may be located at a position other than in a border area of the display surface.

According to a fifth aspect of the disclosure, in the display device of the fourth aspect, the distance sensor may be located in or near a central portion of the display surface.

According to a sixth aspect of the disclosure, in the display device of one of the first through fifth aspects, the display device may change a display mode of at least one of the first image and the second image, based on the distance detected by the distance sensor.

According to a seventh aspect of the disclosure, in the display device of the sixth aspect, if the display device determines that the operation is being performed from the first side of the display surface, it may change the display mode of the first image.

According to an eighth aspect of the disclosure, in the display device of the sixth or seventh aspect, if the display device determines that the operation is being performed from the second side of the display surface, it may change the display mode of the second image.

According to ninth aspect of the disclosure, the display device of one of the first through eighth aspects may further include a touch sensor that is disposed to overlap the display surface as seen from a line normal to the display surface. The display device may change an operation mode of at least one of the first side and the second side of the touch sensor, based on the distance detected by the distance sensor.

According to a tenth aspect of the disclosure, in the display device of the ninth aspect, if the display device determines that the operation is being performed from the first side of the display surface, it may change the operation mode of the first side of the touch sensor.

According to an eleventh aspect of the disclosure, in the display device of the ninth or tenth aspect, if the display device determines that the operation is being performed from the second side of the display surface, it may change the operation mode of the second side of the touch sensor.

A control device according to a twelfth aspect of the disclosure controls a display device. The display device is able to present a first image to a first user positioned on a first side with respect to a display surface and to present a second image to a second user positioned on a second side with respect to the display surface. The second side is a side different from the first side. The second image is an image different from the first image. From a distance sensor that detects a distance between an object and each of multiple partial areas which belong to the display surface, the control device obtains the distance detected by the distance sensor. The control device determines, based on the obtained distance, from which one of the first side and the second side the object is performing an operation for the display surface.

A control method according to a thirteenth aspect of the disclosure is a method for controlling a display device. The display device is able to present a first image to a first user positioned on a first side with respect to a display surface and to present a second image to a second user positioned on a second side with respect to the display surface. The second side is a side different from the first side. The second image is an image different from the first image. The control method includes: obtaining, from a distance sensor that detects a distance between an object and each of multiple partial areas which belong to the display surface, the distance detected by the distance sensor; and determining, based on the obtained distance, from which one of the first side and the second side the object is performing an operation for the display surface.

### APPENDIX

An aspect of the present disclosure is not limited to the above-described embodiments. Various modifications and alterations may be made within the scope of the appended claims or the equivalents thereof. Embodiments obtained by suitably combining technical means disclosed in different embodiments are also encompassed in the technical scope of an aspect of the disclosure. Combining technical means disclosed in embodiments can form another technical feature.

The present disclosure contains subject matter related to that disclosed in Japanese Priority Patent Application JP 2024-147925 filed in the Japan Patent Office on Aug. 29, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

### CROSS-REFERENCE TO RELATED APPLICATION

The present application claims priority from Japanese Application No. 2024-147925, filed on Aug. 29, 2024, the contents of which are hereby incorporated by reference into this application.

What is claimed is:

1. A display device that is able to present a first image to a first user positioned on a first side with respect to a display surface and to present a second image to a second user positioned on a second side with respect to the display surface, the second side being a side different from the first side, the second image being an image different from the first image, the display device comprising:
a distance sensor that detects a distance between an object and each of a plurality of partial areas which belong to the display surface,
wherein the display device determines, based on the distance detected by the distance sensor, from which one of the first side and the second side the object is performing an operation for the display surface.

2. The display device according to claim 1, wherein the distance sensor is an infrared multizone sensor.

3. The display device according to claim 1, wherein the distance sensor is a single distance sensor.

4. The display device according to claim 1, wherein the distance sensor is located at a position other than in a border area of the display surface.

5. The display device according to claim 4, wherein the distance sensor is located in or near a central portion of the display surface.

6. The display device according to claim 1, wherein the display device changes a display mode of at least one of the first image and the second image, based on the distance detected by the distance sensor.

7. The display device according to claim 6, wherein, if the display device determines that the operation is being performed from the first side of the display surface, the display device changes the display mode of the first image.

8. The display device according to claim 6, wherein, if the display device determines that the operation is being performed from the second side of the display surface, the display device changes the display mode of the second image.

9. The display device according to claim 1, further comprising:
a touch sensor that is disposed to overlap the display surface as seen from a line normal to the display surface,
wherein the display device changes an operation mode of at least one of the first side and the second side of the touch sensor, based on the distance detected by the distance sensor.

10. The display device according to claim 9, wherein, if the display device determines that the operation is being performed from the first side of the display surface, the display device changes the operation mode of the first side of the touch sensor.

11. The display device according to claim 9, wherein, if the display device determines that the operation is being performed from the second side of the display surface, the display device changes the operation mode of the second side of the touch sensor.

12. A control device that controls a display device, the display device being able to present a first image to a first user positioned on a first side with respect to a display surface and to present a second image to a second user positioned on a second side with respect to the display surface, the second side being a side different from the first side, the second image being an image different from the first image, wherein
from a distance sensor that detects a distance between an object and each of a plurality of partial areas which belong to the display surface, the control device obtains the distance detected by the distance sensor, and
the control device determines, based on the obtained distance, from which one of the first side and the second side the object is performing an operation for the display surface.

13. A control method for controlling a display device, the display device being able to present a first image to a first user positioned on a first side with respect to a display surface and to present a second image to a second user positioned on a second side with respect to the display surface, the second side being a side different from the first side, the second image being an image different from the first image, the control method comprising:
obtaining, from a distance sensor that detects a distance between an object and each of a plurality of partial areas which belong to the display surface, the distance detected by the distance sensor; and
determining, based on the obtained distance, from which one of the first side and the second side the object is performing an operation for the display surface.
